(19) United States
(12) Patent Application Publication
(10) Pub. No.: US 2024/0362807 A1
(43) Pub. Date: Oct. 31, 2024

(54) SELF-SUPERVISED MULTI-FRAME DEPTH ESTIMATION WITH ODOMETRY FUSION

(71) Applicant: QUALCOMM Incorporated, San Diego, CA (US)

(72) Inventors: Yunxiao Shi, San Diego, CA (US); Amin Ansari, Federal Way, WA (US); Sai Madhuraj Jadhav, San Diego, CA (US); Avdhut Joshi, San Marcos, CA (US)

(21) Appl. No.: 18/309,444

(22) Filed: Apr. 28, 2023

(51) Int. Cl. G06T 7/55; G06T 7/254

(52) U.S. Cl. CPC G06T 7/55; G06T 7/254; G06T 2207/20084; G06T 2207/30252

(57) ABSTRACT

An example device for processing image data includes a processing unit configured to: receive, from a camera of a vehicle, a first image frame at a first time and a second image frame at a second time; receive, from an odometry unit of the vehicle, a first position of the vehicle at the first time and a second position of the vehicle at a second time; calculate a pose difference value representing a difference between the second and first positions; form a pose frame having a size corresponding to the first and second image frames and sample values including the pose difference value; and provide the first and second image frames and the pose frame to a neural networking unit configured to calculate depth for objects in the first image frame and the second image frame, the depth for the objects representing distances between the objects and the vehicle.

### TECHNICAL FIELD

This disclosure relates to artificial intelligence, particularly as applied to autonomous driving systems.

### BACKGROUND

Techniques are being researched and developed related to autonomous driving and advanced driving assistance systems. For example, artificial intelligence and machine learning (AI/ML) systems are being developed and trained to determine how best to operate a vehicle according to applicable traffic laws, safety guidelines, external objects, roads, and the like. Using cameras to collect images, depth estimation is performed to determine depths of objects in the images. Depth estimation can be performed by leveraging various principles, such as calibrated stereo imaging systems and multi-view imaging systems.

Various techniques have been used to perform depth estimation. For example, test-time refinement techniques include applying an entire training pipeline to test frames to update network parameters, which necessitates costly multiple forward and backward passes. Temporal convolutional neural networks rely on stacking of input frames in the channel dimension and bank on the ability of convolutional neural networks to effectively process input channels. Recurrent neural networks may process multiple frames during training, which is computationally demanding due to the need to extract features from multiple frames in a sequence and does not reason about geometry during inference. Techniques using an end-to-end cost volume to aggregate information during training are more efficient than test-time refinement and recurrent approaches, but are still non-trivial and difficult to map to hardware implementations.

### SUMMARY

In general, this disclosure describes techniques for processing image data to determine depths of objects in the image data relative to a position of a vehicle including a camera that captured the image data. An autonomous driving unit of the vehicle may use the depths of the objects when determining an appropriate action to take, such as accelerating, turning, braking, or the like. Depth estimation may be performed using a single camera according to the techniques of this disclosure. In particular, odometry information for the vehicle may be provided, along with image data, to an artificial intelligence/machine learning (AI/ML) unit, such as a neural network, which may be trained to calculate depth of objects in the image data relative to the position of the vehicle when the image data was captured. Such odometry data may be determined using, for example, a global positioning system (GPS) unit, a global navigation satellite system (GNSS) unit, or the like. To provide the odometry information to the AI/ML unit, differences between position data determined by the odometry unit may be represented in the form of a frame including samples, each of the samples having values (e.g., atomic values or vector values) corresponding to the differences.

In one example, a method of processing image data includes receiving, from a camera of a vehicle, a first image frame at a first time; receiving, from an odometry unit of the vehicle, a first position of the vehicle at the first time; receiving, from the camera, a second image frame at a second time; receiving, from the odometry unit of the vehicle, a second position of the vehicle at the second time; calculating, by a processing unit, a pose difference value representing a difference between the second position and the first position; forming, by a processing unit, a pose frame having a size corresponding to the first image frame and the second image frame and sample values including the pose difference value; and providing, by the processing unit, the first image frame, the second image frame, and the pose frame to a neural networking unit configured to calculate depth for objects in the first image frame and the second image frame, the depth for the objects representing distances between the objects and the vehicle.

In another example, a device for processing image data includes a memory configured to store image data; and one or more processors implemented in circuitry and configured to: receive, from a camera of a vehicle, a first image frame at a first time; receive, from an odometry unit of the vehicle, a first position of the vehicle at the first time; receive, from the camera, a second image frame at a second time; receive, from the odometry unit of the vehicle, a second position of the vehicle at the second time; calculate a pose difference value representing a difference between the second position and the first position; form a pose frame having a size corresponding to the first image frame and the second image frame and sample values including the pose difference value; and provide the first image frame, the second image frame, and the pose frame to a neural networking unit configured to calculate depth for objects in the first image frame and the second image frame, the depth for the objects representing distances between the objects and the vehicle.

In another example, a device for processing image data includes means for receiving, from a camera of a vehicle, a first image frame at a first time; means for receiving, from an odometry unit of the vehicle, a first position of the vehicle at the first time; means for receiving, from the camera, a second image frame at a second time; means for receiving, from the odometry unit of the vehicle, a second position of the vehicle at the second time; means for calculating a pose difference value representing a difference between the second position and the first position; means for forming a pose frame having a size corresponding to the first image frame and the second image frame and sample values including the pose difference value; and means for providing the first image frame, the second image frame, and the pose frame to a neural networking unit configured to calculate depth for objects in the first image frame and the second image frame, the depth for the objects representing distances between the objects and the vehicle.

In another example, a computer-readable storage medium has stored thereon instructions that, when executed, cause a processor to receive, from a camera of a vehicle, a first image frame at a first time; receive, from an odometry unit of the vehicle, a first position of the vehicle at the first time; receive, from the camera, a second image frame at a second time; receive, from the odometry unit of the vehicle, a second position of the vehicle at the second time; calculate a pose difference value representing a difference between the second position and the first position; form a pose frame having a size corresponding to the first image frame and the second image frame and sample values including the pose difference value; and provide the first image frame, the second image frame, and the pose frame to a neural networking unit configured to calculate depth for objects in the first image frame and the second image frame, the depth for the objects representing distances between the objects and the vehicle.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example vehicle including an autonomous driving controller according to techniques of this disclosure.

FIG. 2 is a block diagram illustrating an example set of components of an autonomous driving controller according to techniques of this disclosure.

FIG. 3 is a block diagram illustrating an example set of components of a depth determination unit.

FIG. 4 is a conceptual diagram illustrating example images captured at different times to demonstrate motion parallax.

FIG. 5 is a conceptual diagram illustrating example frames that may be provided to a depth determination network according to the techniques of this disclosure.

FIG. 6 is a flowchart illustrating an example method of determining depth for images in objects using odometry data according to techniques of this disclosure.

### DETAILED DESCRIPTION

Depth estimation is an important component of autonomous driving (AD), autonomous driving assistance systems (ADAS), or other systems used to partially or fully autonomously control a vehicle. Depth estimation for such techniques may be used for autonomous driving, assistive robotics, augmented reality/virtual reality scene composition, image editing, or other such techniques.

According to the techniques of this disclosure, depth estimation may be performed using machine learning on monocular video data including a series of images. For example, depth may be estimated using structure from motion (SFM) techniques, which generally include estimating the three-dimensional (3D) structure of a scene from a set of two-dimensional images. Monocular video data refers to video data captured by a single camera. Depth estimation using video data captured by a single camera, as opposed to multiple (two or more) cameras, allows for a reduction in cost by only requiring the single camera, as well as an improvement in simplicity, since no coordination or synchronization between multiple cameras is needed. That is, stereo or multi-view camera systems must be calibrated if performing depth estimation using video data captured by such multiple camera systems, which is cumbersome and prone to errors. By contrast, monocular sequences are relatively easy to capture and sanitize.

The depth estimation techniques of this disclosure may be self-supervised. That is, a depth estimation AI/ML unit, such as a neural network, may be trained on monocular video data in order to detect depths of objects in future monocular video data. Additional sensors, such as LiDAR, are not needed for such training, because LiDAR and other range-finding sensors may be sparse and noisy. Acquiring real-world dense ground-truth depth at scale is also difficult. Instead, the techniques of this disclosure may leverage SFM principles to perform view synthesis as the self-supervision level. Thus, these techniques eliminate the need for ground-truth depth. An abundance of monocular data allows for training such AI/ML units and models.

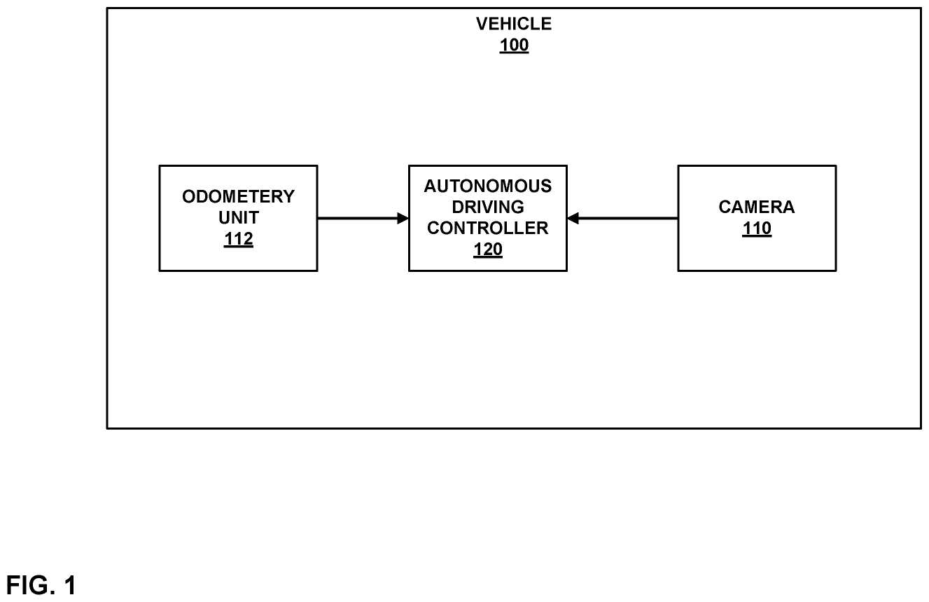

FIG. 1 is a block diagram illustrating an example vehicle 100 including an autonomous driving controller 120 according to techniques of this disclosure. In this example, vehicle 100 includes camera 110, odometry unit 112, and autonomous driving controller 120. Camera 110 is a single camera in this example. While only a single camera is shown in the example of FIG. 1, in other examples, multiple cameras may be used. However, the techniques of this disclosure allow for depth to be calculated for objects in images captured by camera 110 without additional cameras. In some examples, multiple cameras may be employed that face different directions, e.g., front, back, and to each side of vehicle 100. Autonomous driving controller 120 may be configured to calculate depth for objects captured by each of such cameras.

Odometry unit 112 provides odometry data for vehicle 100 to autonomous driving controller 120. While in some cases, odometry unit 112 may correspond to a standard vehicular odometer that measures mileage traveled, in some examples, odometry unit 112 may, additionally or alternatively, correspond to a global positioning system (GPS) unit or a global navigation satellite system (GNSS) unit. In some examples, odometry unit 112 may be a fixed component of vehicle 100. In some examples, odometry unit 112 may represent an interface to a smartphone or other external device that can provide location information representing odometry data to autonomous driving controller 120.

According to the techniques of this disclosure, autonomous driving controller 120 receives frames captured by camera 110 at a high frame rate, such as 30 fps, 60 fps, 90 fps, 120 fps, or even higher. Autonomous driving controller 120 receives odometry data from odometry unit 112 for each image frame. Per the techniques of this disclosure, autonomous driving controller 120 may calculate differences between the odometry data for two consecutive frames, and determine depth for objects in the most recent frame of the two frames using the two frames themselves, as well as the differences between the odometry data for the two frames. For example, autonomous driving controller 120 may construct a pose frame, which may be structured in the same manner as an image frame having a number of samples, and each sample may have a value corresponding to the differences between the odometry data for the two consecutive frames.

In general, the differences between the odometry data may represent either or both of translational differences and/or rotational differences along various axis in three-dimensional space. Thus, for example, assuming that the X-axis is side-to-side of vehicle 100, the Y-axis is up and down of vehicle 100, and the Z-axis is front to back of vehicle 100, translational differences along the X-axis may represent side to side movement of vehicle 100, translational differences along the Y-axis may represent upward or downward movement of vehicle 100, and translational differences along the Z-axis may represent forward or backward movement of vehicle 100. Under the same assumptions, rotational differences about the X-axis may represent pitch changes of vehicle 100, rotational differences about the Y-axis may represent yaw changes of vehicle 100, and rotational differences about the Z-axis may represent roll changes of vehicle 100. When vehicle 100 is an automobile or other ground-based vehicle, translational differences along the Z-axis may provide the most amount of information, with rotational differences about the Y-axis may provide additional useful information (e.g., in response to turning left or right, or remaining straight).

As such, in some examples, autonomous driving controller 120 may construct a pose vector representing translational differences along each of the X-, Y-, and Z-axes between two consecutive image frames ([dX, dY, dZ]). Additionally or alternatively, autonomous driving controller 120 may construct the pose vector to include translational differences along the X- and Z-axes and rotational differences about the Y-axis ([dX, Y, dZ]). Autonomous driving controller 120 may form the pose frame to include three components, similar to RGB components or YUV/YCbCr components of an image frame. However, the pose frame may include X-, Y-, and Z-components, such that each sample of the pose frame includes the pose vector.

For example, the X-component of the pose frame may include samples each having the value of dX of the pose vector, the Y-component of the pose frame may include samples each having the value of dY or rY of the pose vector, and the Z-component of the pose frame may include samples each having the value of dZ. More or fewer components may be used. For example, the pose frame may include only a single Z-component, the Z-component and a Y-component, each of the X-, Y-, and Z-components, or one or two components per axis (e.g., either or both of the translational and/or rotational differences), or any combination thereof for any permutation of the axes.

In this manner, neural networks or other AI/ML units trained to detect depth from two or more images may be configured to accept an additional frame of data structured similarly to an image frame, namely, the pose frame referred to above. The neural networks or other AI/ML units may be trained using such pose frames, then deployed in vehicles to determine depths of objects represented in the image frames. Autonomous driving controller 120 may use the depths of the objects represented in the image frames when determining how best to control vehicle 100, e.g., whether to maintain or adjust speed (e.g., to brake or accelerate), and/or whether to turn left or right or to maintain current heading of vehicle 100.

Additionally or alternatively, these techniques may be employed in advanced driving assistance systems (ADAS). Rather than autonomously controlling vehicle 100, such ADASs may provide feedback to a human operator of vehicle 100, such as a warning to brake or turn if an object is too close. Additionally or alternatively, the techniques of this disclosure may be used to partially control vehicle 100, e.g., to maintain speed of vehicle 100 when no objects within a threshold distance are detected ahead of vehicle 100, or if a separate vehicle is detected ahead of vehicle 100, to match the speed of the separate vehicle if the separate vehicle is within the threshold distance, to prevent reducing the distance between vehicle 100 and the separate vehicle.

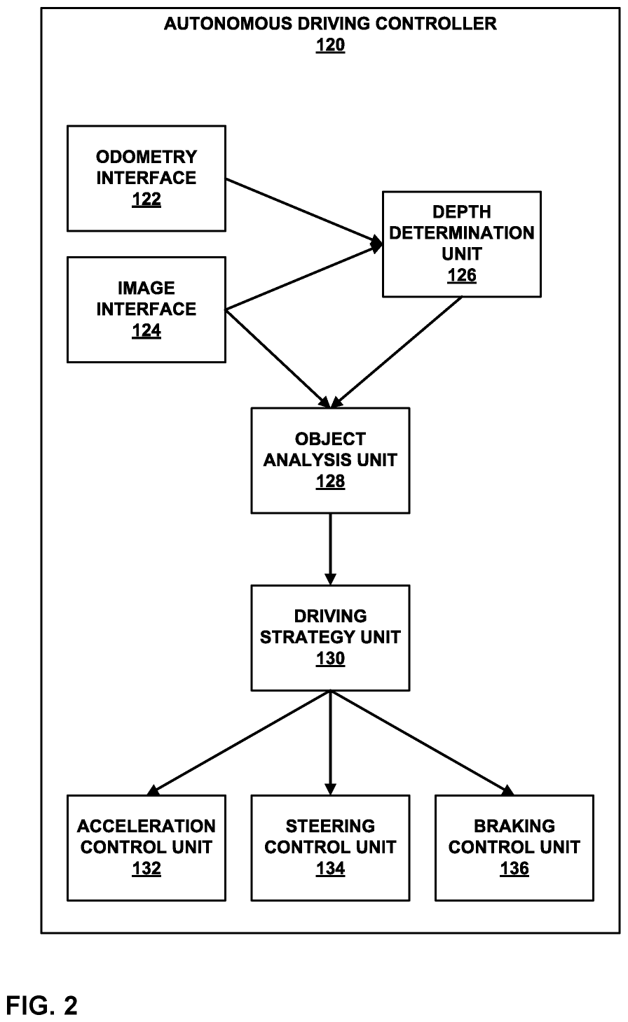

FIG. 2 is a block diagram illustrating an example set of components of autonomous driving controller 120 of FIG. 1 according to techniques of this disclosure. In this example, autonomous driving controller 120 includes odometry interface 122, image interface 124, depth determination unit 126, object analysis unit 128, driving strategy unit 130, acceleration control unit 132, steering control unit 134, and braking control unit 136.

In general, odometry interface 122 represents an interface to odometry unit 112 of FIG. 1, which receives odometry data from odometry unit 112 and provides the odometry data to depth determination unit 126. Similarly, image interface 124 represents an interface to camera 110 of FIG. 1 and provides images to depth determination unit 126.

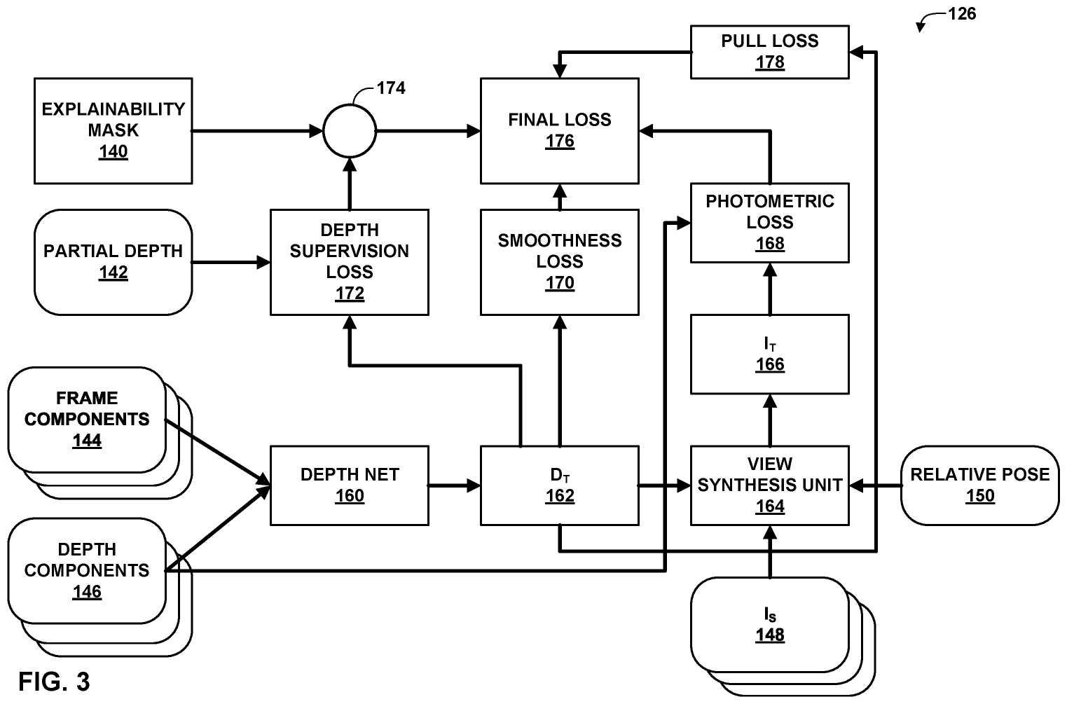

Depth determination unit 126, as explained in greater detail below with respect to FIG. 3, may perform techniques of this disclosure to determine depth of objects represented in images received via image interface 124 using both the images themselves and odometry data received via odometry interface 122. For example, depth determination unit 126 may receive a pair of sequential images from camera 110 via image interface 124, as well as odometry data for vehicle 100 at times when the images were captured. Depth determination unit 126 may determine differences between the odometry data and construct a pose frame that is the same size as the image frames (e.g., including a number of samples that is the same as the number of samples in the image frames). Depth determination unit 126 may provide both of the image frames and the pose frame to a depth determination network thereof to cause the depth determination network to calculate depths of objects depicted in the images.

Image interface 124 may also provide the image frames to object analysis unit 128. Likewise, depth determination unit 126 may provide depth values for objects in the images to object analysis unit 128. Object analysis unit 128 may generally determine where objects are relative to the position of vehicle 100 at a given time, and may also determine whether the objects are stationary or moving. Object analysis unit 128 may provide object data to driving strategy unit 130, which may determine a driving strategy based on the object data. For example, driving strategy unit 130 may determine whether to accelerate, brake, and/or turn vehicle 100. Driving strategy unit 130 may execute the determined strategy by delivering vehicle control signals to various driving systems (acceleration, braking, and/or steering) via acceleration control unit 132, steering control unit 134, and braking control unit 136.

The various components of autonomous driving controller 120 may be implemented as any of a variety of suitable circuitry components, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure.

FIG. 3 is a block diagram illustrating an example set of components of depth determination unit 126 of FIG. 2. Depth determination unit 126 includes depth net 160, DT 162, view synthesis unit 164, IT 166, photometric loss 168, smoothness loss 170, depth supervision loss 172, combination unit 174, final loss 176, and pull loss 178. As shown in the example of FIG. 3, depth determination unit 126 receives explainability mask 140, partial depth 142, frame components 144, depth components 146, Is 148, and relative pose data 150.

Frame components 144 correspond to components (e.g., R. G, and B components or Y, U, and V/Y, Cb, and Cr components) of image frames, e.g., received from camera 110 of FIG. 1. Depth components 146 correspond to components (e.g., X, Y, and/or Z components) corresponding to differences along or about X-, Y-, and/or Z-axes between odometry data for times at which the image frames were captured. Depth net 160 represents a depth learning AI/ML unit, such as a neural network, trained to determine depth values for objects included in the image frames using the odometry data.

D_{T} 162 represents a depth map at time T (corresponding to the time at which the later image was captured) as calculated by depth net 160.

View synthesis unit 164 may synthesize one or more additional views using original image frames (I_{S} 148) and the depth map, i.e., D_{T} 162, as well as relative pose data 150. That is, using the depth map and relative pose data 150, view synthesis unit 164 may warp samples of the original image frames to produce one or more warped image frames, such that the samples of the original image frames are moved horizontally according to the determined depth values for the object to which the samples correspond. Relative pose data 150 may be measured or estimated by a pose network. I_{T} 166 represents the resulting warped image generated by view synthesis unit 164.

Photometric loss unit 168 may calculate photometric loss, representing photometric differences between pixels warped from the received image frames and the pixels in the warped image, i.e., I_{T} 166. Photometric loss unit 168 may provide the photometric loss to final loss unit 176.

Smoothness loss unit 170 may calculate smoothness loss of the depth map, i.e., D_{T} 162. Smoothness loss generally represents a degree to which depth values are smooth, e.g., represent geometrically natural depth. Smoothness loss unit 170 may provide the smoothness loss to final loss unit 176.

Depth supervision loss unit 172 may calculate depth supervision loss of the depth map, i.e., D_{T} 162, using partial depth data 142.

Explainability mask 140 generally represents confidence values, i.e., values indicating how confident depth net 160 is for various regions/samples of calculated depth maps, such as D_{T} 162. Thus, combination unit 174 may apply explainability mask 140 to the depth supervision loss calculated by depth supervision loss unit 172 and provide this masked input to final loss unit 176.

Pull loss unit 178 may calculate pull loss, representing a degree to which corners of an object are accurately joined in the depth map, i.e., D_{T} 162. Pull loss unit 178 may receive data representing input shapes to calculate the pull loss. Pull loss unit 178 may provide the pull loss to final loss unit 176. The pull loss may act as a prior value for depth values to get the depth values to a predetermined set, which may help with areas for which data may not be readily understandable, such as open sky.

Ultimately, final loss unit 176 may calculate final loss, representing overall accuracy of the depth map, D_{T} 162. The final loss may be minimized during an optimization process when training depth net 160. An optimizer for minimizing the final loss may be, for example, stochastic gradient descent, ADAM, NADAM, AdaGrad, or the like. During backpropagation of optimization, gradient values may flow backward through the final loss to other parts of the network.

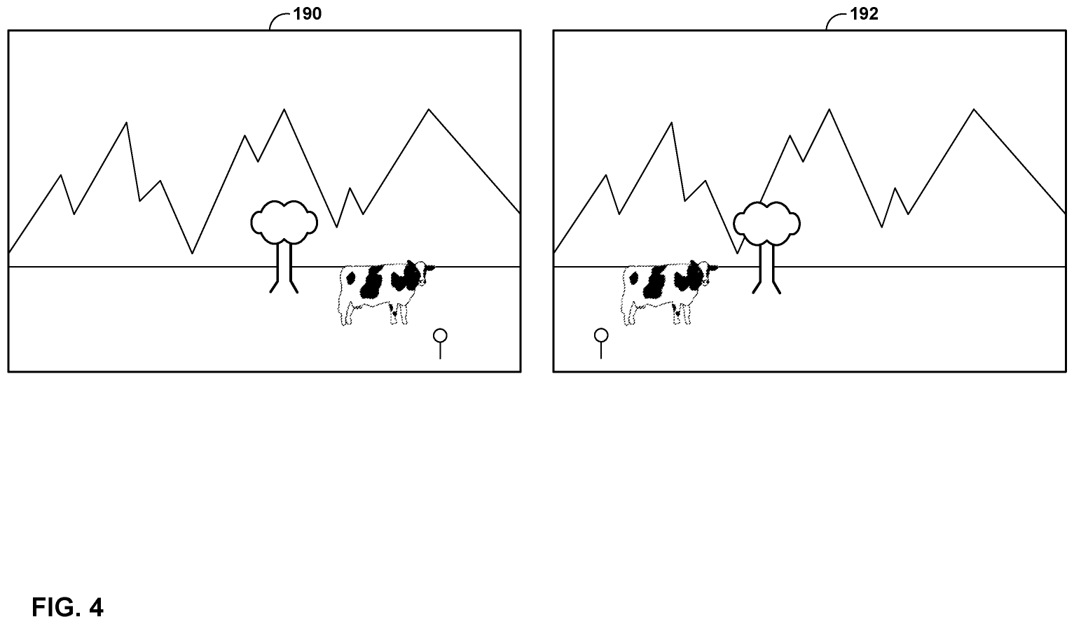

FIG. 4 is a conceptual diagram illustrating example images 190A, 190B captured at different times to demonstrate motion parallax. Motion parallax is generally the concept that objects moving at a constant speed across a frame of image data will appear to move a greater amount if they are closer to the camera than objects at further distances.

In the example of FIG. 4, it is assumed that image 190A is captured by a camera at a first time, and that image 190B is captured by the camera at a second, later time. The camera is assumed to be mounted in a vehicle that is traveling parallel with the mountains in the distance of images 190A, 190B. Thus, as can be seen in the example of FIG. 4, objects closer to the camera, such as the flower and cow, appear to move more than objects further from the camera, such as the tree, and the mountains in the far distance appear not to move at all between images 190A and 190B.

By taking advantage of odometry information, a neural network may take advantage of motion parallax. Research into the techniques of this disclosure demonstrated that lacking such odometry information results in suboptimal estimation of a depth map, especially in scenarios in which a vehicle pose is drastically/unpredictably changing between captured frames.

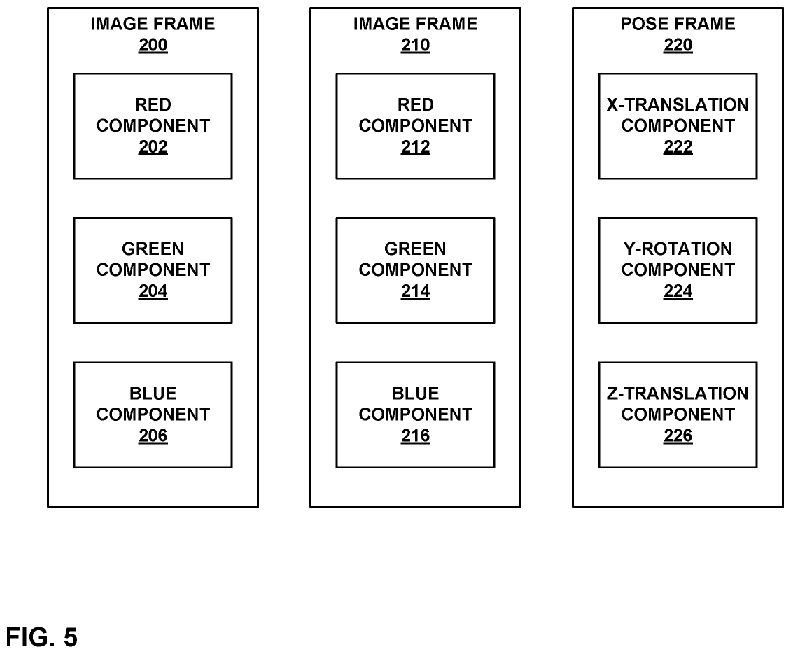

FIG. 5 is a conceptual diagram illustrating example frames that may be provided to a depth determination network according to the techniques of this disclosure. FIG. 5 depicts three frames: image frame 200, image frame 210, and pose frame 220. Image frame 200 includes red component 202, green component 204, and blue component 206, while image frame 210 includes red component 212, green component 214, and blue component 216. In general, each of the red, green, and blue components includes data for each sample of the corresponding image frames representing intensity as measured by corresponding red, green, or blue elements of an image sensor. Thus, a given sample of an image frame may be represented as a vector [R, G, B], where R represents an red value, G represents a green value, and B represents a blue value. While RGB is used in this example, in other examples, other image formats may be used, such as YUV or YCbCr, where Y represents luminance (brightness), U/Cb represents blue hue chrominance, and V/Cr represents red hue chrominance.

Furthermore, in FIG. 5, pose frame 220 includes X-translation component 222. Y-rotation component 224, and Z-translation component 226. In general, pose frame 220 may include common values (vectors) for each sample across pose frame 220. Thus, X-translation component 222 may represent a difference in X-axis values as measured by, e.g., odometry unit 112 of FIG. 1 between times when image frame 200 and image frame 210 were captured. Similarly, Y-rotation component 224 may represent rotation about the Y-axis between the times when image frame 200 and image frame 210 were captured. Likewise, Z-translation component 226 may represent a difference in Z-axis values as measured by, e.g., odometry unit 112 of FIG. 1 between times when image frame 200 and image frame 210 were captured.

Thus, each sample of pose frame 220 may have identical values/vectors, such as an [X, Y, Z] vector, where X represents the difference in the X-axis values, Y represents the rotation along the Y-axis, and Z represents the difference in the Z-axis values. In other examples, additional, alternative, or fewer components may be included in pose frame 220. For example, a pose frame may include only a single Z-translation component (similar to a monochromatic image), two components, such as a Z-translation component and a Y-rotation component, each of a Z-translation component, a Y-translation component, and a Y-rotation component, with or without an X-translation and/or X-rotation component, or any various combination thereof.

More generally, pose frame 220 may represent a six degrees of freedom (6DoF) transformation between positions of a vehicle (e.g., vehicle 100) at times when image frame 200 and image frame 210 were captured. Camera poses may be recorded by odometry unit 112 of FIG. 1, which again, may be a GPS unit, a GNSS unit, an interface to an external unit such as a smartphone that provides location information, or the like.

Heuristic testing of the techniques of this disclosure yielded experimental results as follows. Baseline depth estimation accuracy results were as follows:

| | | | | RMSE_{—} | | | |
|---|---|---|---|---|---|---|---|
| Abs_rel | MAE | RMSE | SQ_REL | Log | A1 | A2 | A3 |
| 0.063 | 2.906 | 7.501 | 1.22 | 0.156 | 0.949 | 0.969 | 0.980 |

When translational differences along each of the X-, Y-, and Z-axes were used, depth estimation accuracy results were as follows:

| | | | | RMSE_{—} | | | |
|---|---|---|---|---|---|---|---|
| Abs_rel | MAE | RMSE | SQ_REL | Log | A1 | A2 | A3 |
| 0.061 | 2.793 | 7.293 | 1.128 | 0.153 | 0.951 | 0.970 | 0.981 |

When translational differences along the X- and Z-axes and rotation about the Y-axis was used, depth estimation accuracy results were as follows:

| | | | | RMSE_{—} | | | |
|---|---|---|---|---|---|---|---|
| Abs_rel | MAE | RMSE | SQ_REL | Log | A1 | A2 | A3 |
| 0.059 | 2.756 | 7.262 | 1.081 | 0.153 | 0.952 | 0.969 | 0.980 |

In the tables above, “abs_rel” represents absolute relative error (lower is better), “MAE” represents mean absolute error (lower is better), “RMSE” represents root mean squared error (lower is better), “SQ_REL” represents squared relative error (lower is better), RMSE_log represents a logarithmic value of RMSE (lower is better), and A1-A3 represent fitness values (closer to 1 is better).

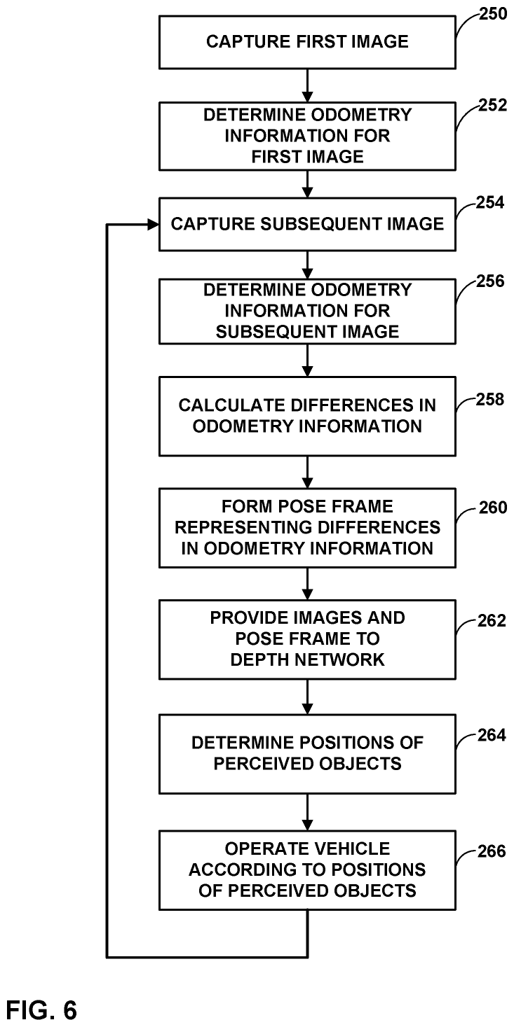

FIG. 6 is a flowchart illustrating an example method of determining depth for images in objects using odometry data according to techniques of this disclosure. The method of FIG. 6 is described with respect to autonomous driving controller 120 of FIGS. 1 and 2 for purposes of explanation.

Initially, autonomous driving controller 120 receives a first captured image (250), e.g., from camera 110. Autonomous driving controller 120 also receives odometry information for the first image (252), e.g., from odometry unit 112. That is, autonomous driving controller 120 may receive odometry information indicating a position/orientation of vehicle 100 at the time the first image was captured. Autonomous driving controller 120 further receives a subsequent captured image (254) from camera 110 at a later time, and also receives odometry information for the subsequent image (256), that is, odometry information indicating a position/orientation of vehicle 100 at the time the subsequent image was captured.

Autonomous driving controller 120 may then calculate one or more differences in the odometry information (258), that is, differences between the odometry information for the subsequent image and the odometry information for the first image. The differences may be differences in translation along and/or rotation about a three-dimensional axis. In some examples, the differences may include a single difference along the Z-axis, i.e., the direction of forward movement of vehicle 100. In some examples, the differences may, additionally or alternatively, include rotation about the Y-axis, i.e., the up/down axis relative to vehicle 100. In some examples, the differences may, additionally or alternatively, include translation along the X-axis, i.e., the left/right axis relative to vehicle 100.

Autonomous driving controller 120 may then form a vector including values for each of the calculated differences in odometry information. Autonomous driving controller 120 may form a pose frame representing the differences in the odometry information (260). For example, the pose frame may include a set of components, similar to color components of an image frame. Each component may correspond to one of the sets of differences for a particular one of the axis. Thus, the pose frame may include an X-component, a Y-component, and a Z-component. Each sample of the X-component may include the value of the X-axis difference between the odometry information for the subsequent frame and the odometry information for the first frame. Each sample of the Y-component may include the value of the Y-axis difference between the odometry information for the subsequent frame and the odometry information for the first frame. Each sample of the Z-component may include the value of the Z-axis difference between the odometry information for the subsequent frame and the odometry information for the first frame.

Autonomous driving controller 120 may then provide the images and the pose frame to a depth network (262), such as depth net 160 of depth determination unit 126 of FIGS. 2 and 3. Autonomous driving controller 120 may then determine positions of perceived objects (264) in the subsequent frame using depth information determined by the depth network. Autonomous driving controller 120 may then operate the vehicle according to the positions of the perceived objects (266). For example, if there are no perceived objects in front of vehicle 100, autonomous driving controller 120 may maintain a current speed and heading. As another example if there is an approaching object, such as another vehicle, in front of vehicle 100, autonomous driving controller 120 may brake and/or turn vehicle 100.

In this manner, the method of FIG. 6 represents an example of a method of processing image data including receiving, from a camera of a vehicle, a first image frame at a first time; receiving, from an odometry unit of the vehicle, a first position of the vehicle at the first time; receiving, from the camera, a second image frame at a second time; receiving, from the odometry unit of the vehicle, a second position of the vehicle at the second time; calculating, by a processing unit, a pose difference value representing a difference between the second position and the first position; forming, by a processing unit, a pose frame having a size corresponding to the first image frame and the second image frame and sample values including the pose difference value; and providing, by the processing unit, the first image frame, the second image frame, and the pose frame to a neural networking unit configured to calculate depth for objects in the first image frame and the second image frame, the depth for the objects representing distances between the objects and the vehicle.

Various examples of the techniques of this disclosure are summarized in the following clauses:
Clause 1. A method of processing image data, the method comprising: receiving, from a camera of a vehicle, a first image frame at a first time; receiving, from an odometry unit of the vehicle, a first position of the vehicle at the first time; receiving, from the camera, a second image frame at a second time; receiving, from the odometry unit of the vehicle, a second position of the vehicle at the second time; calculating, by a processing unit, a pose difference value representing a difference between the second position and the first position; forming, by a processing unit, a pose frame having a size corresponding to the first image frame and the second image frame and sample values including the pose difference value; and providing, by the processing unit, the first image frame, the second image frame, and the pose frame to a neural networking unit configured to calculate depth for objects in the first image frame and the second image frame, the depth for the objects representing distances between the objects and the vehicle.
Clause 2. The method of clause 1, wherein the first position includes a first Z-axis value, the second position includes a second Z-axis value, and the pose difference value represents a difference between the second Z-axis value and the first Z-axis value.
Clause 3. The method of any of clauses 1 and 2, wherein the first position includes a first X-axis value, the second position includes a second X-axis value, and the pose difference value represents a difference between the second X-axis value and the first X-axis value.
Clause 4. The method of any of clauses 1-3, wherein the first position includes a first Y-axis value, the second position includes a second Y-axis value, and the pose difference value represents a difference between the second Y-axis value and the first Y-axis value.
Clause 5. The method of any of clauses 1-3, wherein the first position includes a first Y-axis value, the second position includes a second Y-axis value, and the pose difference value represents a rotation from the first Y-axis value to the second Y-axis value.
Clause 6. The method of any of clauses 4 and 5, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.
Clause 7. The method of any of clauses 1-6, wherein the odometry unit comprises one or more of a vehicle odometer, a global positioning system (GPS) unit, a global navigation satellite system (GNSS) unit, or a smartphone-based location unit.
Clause 8. A device for processing image data, the device comprising: a memory configured to store image data; and one or more processors implemented in circuitry and configured to: receive, from a camera of a vehicle, a first image frame at a first time; receive, from an odometry unit of the vehicle, a first position of the vehicle at the first time; receive, from the camera, a second image frame at a second time; receive, from the odometry unit of the vehicle, a second position of the vehicle at the second time; calculate a pose difference value representing a difference between the second position and the first position; form a pose frame having a size corresponding to the first image frame and the second image frame and sample values including the pose difference value; and provide the first image frame, the second image frame, and the pose frame to a neural networking unit configured to calculate depth for objects in the first image frame and the second image frame, the depth for the objects representing distances between the objects and the vehicle.
Clause 9. The device of clause 8, wherein the first position includes a first Z-axis value, the second position includes a second Z-axis value, and the pose difference value represents a difference between the second Z-axis value and the first Z-axis value.
Clause 10. The device of any of clauses 8 and 9, wherein the first position includes a first X-axis value, the second position includes a second X-axis value, and the pose difference value represents a difference between the second X-axis value and the first X-axis value.
Clause 11. The device of any of clauses 8-10, wherein the first position includes a first Y-axis value, the second position includes a second Y-axis value, and the pose difference value represents a difference between the second Y-axis value and the first Y-axis value.
Clause 12. The device of any of clauses 8-10, wherein the first position includes a first Y-axis value, the second position includes a second Y-axis value, and the pose difference value represents a rotation from the first Y-axis value to the second Y-axis value.
Clause 13. The device of any of clauses 11 and 12, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.
Clause 14. The device of any of clauses 8-13, wherein the odometry unit comprises one or more of a vehicle odometer, a global positioning system (GPS) unit, a global navigation satellite system (GNSS) unit, or a smartphone-based location unit.
Clause 15. A computer-readable storage medium having stored thereon instructions that, when executed, cause a processor to: receive, from a camera of a vehicle, a first image frame at a first time; receive, from an odometry unit of the vehicle, a first position of the vehicle at the first time; receive, from the camera, a second image frame at a second time; receive, from the odometry unit of the vehicle, a second position of the vehicle at the second time; calculate a pose difference value representing a difference between the second position and the first position; form a pose frame having a size corresponding to the first image frame and the second image frame and sample values including the pose difference value; and provide the first image frame, the second image frame, and the pose frame to a neural networking unit configured to calculate depth for objects in the first image frame and the second image frame, the depth for the objects representing distances between the objects and the vehicle.
Clause 16. The computer-readable storage medium of clause 15, wherein the first position includes a first Z-axis value, the second position includes a second Z-axis value, and the pose difference value represents a difference between the second Z-axis value and the first Z-axis value.
Clause 17. The computer-readable storage medium of any of clauses 15 and 16, wherein the first position includes a first X-axis value, the second position includes a second X-axis value, and the pose difference value represents a difference between the second X-axis value and the first X-axis value.
Clause 18. The computer-readable storage medium of any of clauses 15-17, wherein the first position includes a first Y-axis value, the second position includes a second Y-axis value, and the pose difference value represents a difference between the second Y-axis value and the first Y-axis value.
Clause 19. The computer-readable storage medium of any of clauses 15-17, wherein the first position includes a first Y-axis value, the second position includes a second Y-axis value, and the pose difference value represents a rotation from the first Y-axis value to the second Y-axis value.
Clause 20. The computer-readable storage medium of any of clauses 18 and 19, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.
Clause 21. The computer-readable storage medium of any of clauses 15-20, wherein the odometry unit comprises one or more of a vehicle odometer, a global positioning system (GPS) unit, a global navigation satellite system (GNSS) unit, or a smartphone-based location unit.
Clause 22. A device for processing image data, the device comprising: means for receiving, from a camera of a vehicle, a first image frame at a first time; means for receiving, from an odometry unit of the vehicle, a first position of the vehicle at the first time; means for receiving, from the camera, a second image frame at a second time; means for receiving, from the odometry unit of the vehicle, a second position of the vehicle at the second time; means for calculating a pose difference value representing a difference between the second position and the first position; means for forming a pose frame having a size corresponding to the first image frame and the second image frame and sample values including the pose difference value; and means for providing the first image frame, the second image frame, and the pose frame to a neural networking unit configured to calculate depth for objects in the first image frame and the second image frame, the depth for the objects representing distances between the objects and the vehicle.
Clause 23. The device of clause 22, wherein the first position includes a first Z-axis value, the second position includes a second Z-axis value, and the pose difference value represents a difference between the second Z-axis value and the first Z-axis value.
Clause 24. The device of any of clauses 22 and 23, wherein the first position includes a first X-axis value, the second position includes a second X-axis value, and the pose difference value represents a difference between the second X-axis value and the first X-axis value.
Clause 25. The device of any of clauses 22-24, wherein the first position includes a first Y-axis value, the second position includes a second Y-axis value, and the pose difference value represents a difference between the second Y-axis value and the first Y-axis value.
Clause 26. The device of any of clauses 22-24, wherein the first position includes a first Y-axis value, the second position includes a second Y-axis value, and the pose difference value represents a rotation from the first Y-axis value to the second Y-axis value.
Clause 27. The device of any of clauses 25 and 26, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.
Clause 28. The device of any of clauses 22-27, wherein the odometry unit comprises one or more of a vehicle odometer, a global positioning system (GPS) unit, a global navigation satellite system (GNSS) unit, or a smartphone-based location unit.
Clause 29. A method of processing image data, the method comprising: receiving, from a camera of a vehicle, a first image frame at a first time; receiving, from an odometry unit of the vehicle, a first position of the vehicle at the first time; receiving, from the camera, a second image frame at a second time; receiving, from the odometry unit of the vehicle, a second position of the vehicle at the second time; calculating, by a processing unit, a pose difference value representing a difference between the second position and the first position; forming, by a processing unit, a pose frame having a size corresponding to the first image frame and the second image frame and sample values including the pose difference value; and providing, by the processing unit, the first image frame, the second image frame, and the pose frame to a neural networking unit configured to calculate depth for objects in the first image frame and the second image frame, the depth for the objects representing distances between the objects and the vehicle.
Clause 30. The method of clause 29, wherein the first position includes a first Z-axis value, the second position includes a second Z-axis value, and the pose difference value represents a difference between the second Z-axis value and the first Z-axis value.
Clause 31. The method of clause 29, wherein the first position includes a first X-axis value and a first Z-axis value, the second position includes a second X-axis value and a second Z-axis value, and the pose difference value represents a first difference between the second X-axis value and the first X-axis value and a second difference between the second Z-axis value and the first Z-axis value.
Clause 32. The method of clause 29, wherein the first position includes a first X-axis value, a first Y-axis value, and a first Z-axis value, the second position includes a second X-axis value, a second Y-axis value, and a second Z-axis value, and the pose difference value represents a first difference between the second X-axis value and the first X-axis value, a second difference between the second Y-axis value and the first Y-axis value, and a third difference between the second Z-axis value and the first Z-axis value.
Clause 33. The method of clause 32, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.
Clause 34. The method of clause 29, wherein the first position includes a first X-axis value, a first Y-axis value, and a first Z-axis value, the second position includes a second X-axis value, a second Y-axis value, and a second Z-axis value, and the pose difference value represents a first difference between the second X-axis value and the first X-axis value, a rotation between the first Y-axis value and the second Y-axis value, and a second difference between the second Z-axis value and the first Z-axis value.
Clause 35. The method of clause 34, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.
Clause 36. The method of clause 29, wherein the odometry unit comprises one or more of a vehicle odometer, a global positioning system (GPS) unit, a global navigation satellite system (GNSS) unit, or a smartphone-based location unit.
Clause 37. A device for processing image data, the device comprising: a memory configured to store image data; and one or more processors implemented in circuitry and configured to: receive, from a camera of a vehicle, a first image frame at a first time; receive, from an odometry unit of the vehicle, a first position of the vehicle at the first time; receive, from the camera, a second image frame at a second time; receive, from the odometry unit of the vehicle, a second position of the vehicle at the second time; calculate a pose difference value representing a difference between the second position and the first position; form a pose frame having a size corresponding to the first image frame and the second image frame and sample values including the pose difference value; and provide the first image frame, the second image frame, and the pose frame to a neural networking unit configured to calculate depth for objects in the first image frame and the second image frame, the depth for the objects representing distances between the objects and the vehicle.
Clause 38. The device of clause 37, wherein the first position includes a first Z-axis value, the second position includes a second Z-axis value, and the pose difference value represents a difference between the second Z-axis value and the first Z-axis value.
Clause 39. The device of clause 37, wherein the first position includes a first X-axis value and a first Z-axis value, the second position includes a second X-axis value and a second Z-axis value, and the pose difference value represents a first difference between the second X-axis value and the first X-axis value and a second difference between the second Z-axis value and the first Z-axis value.
Clause 40. The device of clause 37, wherein the first position includes a first X-axis value, a first Y-axis value, and a first Z-axis value, the second position includes a second X-axis value, a second Y-axis value, and a second Z-axis value, and the pose difference value represents a first difference between the second X-axis value and the first X-axis value, a second difference between the second Y-axis value and the first Y-axis value, and a third difference between the second Z-axis value and the first Z-axis value.
Clause 41. The device of clause 40, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.
Clause 42. The device of clause 37, wherein the first position includes a first X-axis value, a first Y-axis value, and a first Z-axis value, the second position includes a second X-axis value, a second Y-axis value, and a second Z-axis value, and the pose difference value represents a first difference between the second X-axis value and the first X-axis value, a rotation between the first Y-axis value and the second Y-axis value, and a second difference between the second Z-axis value and the first Z-axis value.
Clause 43. The device of clause 42, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.
Clause 44. The device clause 37, wherein the odometry unit comprises one or more of a vehicle odometer, a global positioning system (GPS) unit, a global navigation satellite system (GNSS) unit, or a smartphone-based location unit.
Clause 45. A computer-readable storage medium having stored thereon instructions that, when executed, cause a processor to: receive, from a camera of a vehicle, a first image frame at a first time; receive, from an odometry unit of the vehicle, a first position of the vehicle at the first time; receive, from the camera, a second image frame at a second time; receive, from the odometry unit of the vehicle, a second position of the vehicle at the second time; calculate a pose difference value representing a difference between the second position and the first position; form a pose frame having a size corresponding to the first image frame and the second image frame and sample values including the pose difference value; and provide the first image frame, the second image frame, and the pose frame to a neural networking unit configured to calculate depth for objects in the first image frame and the second image frame, the depth for the objects representing distances between the objects and the vehicle.
Clause 46. The computer-readable storage medium of clause 45, wherein the first position includes a first Z-axis value, the second position includes a second Z-axis value, and the pose difference value represents a difference between the second Z-axis value and the first Z-axis value.
Clause 47. The computer-readable storage medium of clause 45, wherein the first position includes a first X-axis value and a first Z-axis value, the second position includes a second X-axis value and a second Z-axis value, and the pose difference value represents a first difference between the second X-axis value and the first X-axis value and a second difference between the second Z-axis value and the first Z-axis value.
Clause 48. The computer-readable storage medium of clause 45, wherein the first position includes a first X-axis value, a first Y-axis value, and a first Z-axis value, the second position includes a second X-axis value, a second Y-axis value, and a second Z-axis value, and the pose difference value represents a first difference between the second X-axis value and the first X-axis value, a second difference between the second Y-axis value and the first Y-axis value, and a third difference between the second Z-axis value and the first Z-axis value.
Clause 49. The computer-readable storage medium of clause 48, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.
Clause 50. The computer-readable storage medium of clause 45, wherein the first position includes a first X-axis value, a first Y-axis value, and a first Z-axis value, the second position includes a second X-axis value, a second Y-axis value, and a second Z-axis value, and the pose difference value represents a first difference between the second X-axis value and the first X-axis value, a rotation between the first Y-axis value and the second Y-axis value, and a second difference between the second Z-axis value and the first Z-axis value.
Clause 51. The computer-readable storage medium of clause 50, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.
Clause 52. The computer-readable storage medium of clause 45, wherein the odometry unit comprises one or more of a vehicle odometer, a global positioning system (GPS) unit, a global navigation satellite system (GNSS) unit, or a smartphone-based location unit.
Clause 53. A device for processing image data, the device comprising: means for receiving, from a camera of a vehicle, a first image frame at a first time; means for receiving, from an odometry unit of the vehicle, a first position of the vehicle at the first time; means for receiving, from the camera, a second image frame at a second time; means for receiving, from the odometry unit of the vehicle, a second position of the vehicle at the second time; means for calculating a pose difference value representing a difference between the second position and the first position; means for forming a pose frame having a size corresponding to the first image frame and the second image frame and sample values including the pose difference value; and means for providing the first image frame, the second image frame, and the pose frame to a neural networking unit configured to calculate depth for objects in the first image frame and the second image frame, the depth for the objects representing distances between the objects and the vehicle.
Clause 54. The device of clause 53, wherein the first position includes a first Z-axis value, the second position includes a second Z-axis value, and the pose difference value represents a difference between the second Z-axis value and the first Z-axis value.
Clause 55. The device of clause 53, wherein the first position includes a first X-axis value and a first Z-axis value, the second position includes a second X-axis value and a second Z-axis value, and the pose difference value represents a first difference between the second X-axis value and the first X-axis value and a second difference between the second Z-axis value and the first Z-axis value.
Clause 56. The device of clause 53, wherein the first position includes a first X-axis value, a first Y-axis value, and a first Z-axis value, the second position includes a second X-axis value, a second Y-axis value, and a second Z-axis value, and the pose difference value represents a first difference between the second X-axis value and the first X-axis value, a second difference between the second Y-axis value and the first Y-axis value, and a third difference between the second Z-axis value and the first Z-axis value.
Clause 57. The device of clause 56, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.
Clause 58. The device of clause 53, wherein the first position includes a first X-axis value, a first Y-axis value, and a first Z-axis value, the second position includes a second X-axis value, a second Y-axis value, and a second Z-axis value, and the pose difference value represents a first difference between the second X-axis value and the first X-axis value, a rotation between the first Y-axis value and the second Y-axis value, and a second difference between the second Z-axis value and the first Z-axis value.
Clause 59. The device of clause 58, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.
Clause 60. The device of clause 53, wherein the odometry unit comprises one or more of a vehicle odometer, a global positioning system (GPS) unit, a global navigation satellite system (GNSS) unit, or a smartphone-based location unit.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing image data, the method comprising:
receiving, from a camera of a vehicle, a first image frame at a first time;
receiving, from an odometry unit of the vehicle, a first position of the vehicle at the first time;
receiving, from the camera, a second image frame at a second time;
receiving, from the odometry unit of the vehicle, a second position of the vehicle at the second time;
calculating, by a processing unit, a pose difference value representing a difference between the second position and the first position;
forming, by a processing unit, a pose frame having a size corresponding to the first image frame and the second image frame and sample values including the pose difference value; and
providing, by the processing unit, the first image frame, the second image frame, and the pose frame to a neural networking unit configured to calculate depth for objects in the first image frame and the second image frame, the depth for the objects representing distances between the objects and the vehicle.

2. The method of claim 1, wherein the first position includes a first Z-axis value, the second position includes a second Z-axis value, and the pose difference value represents a difference between the second Z-axis value and the first Z-axis value.

3. The method of claim 1, wherein the first position includes a first X-axis value and a first Z-axis value, the second position includes a second X-axis value and a second Z-axis value, and the pose difference value represents a first difference between the second X-axis value and the first X-axis value and a second difference between the second Z-axis value and the first Z-axis value.

4. The method of claim 1, wherein the first position includes a first X-axis value, a first Y-axis value, and a first Z-axis value, the second position includes a second X-axis value, a second Y-axis value, and a second Z-axis value, and the pose difference value represents a first difference between the second X-axis value and the first X-axis value, a second difference between the second Y-axis value and the first Y-axis value, and a third difference between the second Z-axis value and the first Z-axis value.

5. The method of claim 4, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.

6. The method of claim 1, wherein the first position includes a first X-axis value, a first Y-axis value, and a first Z-axis value, the second position includes a second X-axis value, a second Y-axis value, and a second Z-axis value, and the pose difference value represents a first difference between the second X-axis value and the first X-axis value, a rotation between the first Y-axis value and the second Y-axis value, and a second difference between the second Z-axis value and the first Z-axis value.

7. The method of claim 6, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.

8. The method of claim 1, wherein the odometry unit comprises one or more of a vehicle odometer, a global positioning system (GPS) unit, a global navigation satellite system (GNSS) unit, or a smartphone-based location unit.

9. A device for processing image data, the device comprising:
a memory configured to store image data; and
one or more processors implemented in circuitry and configured to:
receive, from a camera of a vehicle, a first image frame at a first time;
receive, from an odometry unit of the vehicle, a first position of the vehicle at the first time;
receive, from the camera, a second image frame at a second time;
receive, from the odometry unit of the vehicle, a second position of the vehicle at the second time;
calculate a pose difference value representing a difference between the second position and the first position;
form a pose frame having a size corresponding to the first image frame and the second image frame and sample values including the pose difference value; and
provide the first image frame, the second image frame, and the pose frame to a neural networking unit configured to calculate depth for objects in the first image frame and the second image frame, the depth for the objects representing distances between the objects and the vehicle.

10. The device of claim 9, wherein the first position includes a first Z-axis value, the second position includes a second Z-axis value, and the pose difference value represents a difference between the second Z-axis value and the first Z-axis value.

11. The device of claim 9, wherein the first position includes a first X-axis value and a first Z-axis value, the second position includes a second X-axis value and a second Z-axis value, and the pose difference value represents a first difference between the second X-axis value and the first X-axis value and a second difference between the second Z-axis value and the first Z-axis value.

12. The device of claim 9, wherein the first position includes a first X-axis value, a first Y-axis value, and a first Z-axis value, the second position includes a second X-axis value, a second Y-axis value, and a second Z-axis value, and the pose difference value represents a first difference between the second X-axis value and the first X-axis value, a second difference between the second Y-axis value and the first Y-axis value, and a third difference between the second Z-axis value and the first Z-axis value.

13. The device of claim 12, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.

14. The device of claim 9, wherein the first position includes a first X-axis value, a first Y-axis value, and a first Z-axis value, the second position includes a second X-axis value, a second Y-axis value, and a second Z-axis value, and the pose difference value represents a first difference between the second X-axis value and the first X-axis value, a rotation between the first Y-axis value and the second Y-axis value, and a second difference between the second Z-axis value and the first Z-axis value.

15. The device of claim 14, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.

16. The device of claim 9, wherein the odometry unit comprises one or more of a vehicle odometer, a global positioning system (GPS) unit, a global navigation satellite system (GNSS) unit, or a smartphone-based location unit.

17. A device for processing image data, the device comprising:
means for receiving, from a camera of a vehicle, a first image frame at a first time;
means for receiving, from an odometry unit of the vehicle, a first position of the vehicle at the first time;
means for receiving, from the camera, a second image frame at a second time;
means for receiving, from the odometry unit of the vehicle, a second position of the vehicle at the second time;
means for calculating a pose difference value representing a difference between the second position and the first position;
means for forming a pose frame having a size corresponding to the first image frame and the second image frame and sample values including the pose difference value; and
means for providing the first image frame, the second image frame, and the pose frame to a neural networking unit configured to calculate depth for objects in the first image frame and the second image frame, the depth for the objects representing distances between the objects and the vehicle.

18. The device of claim 17, wherein the first position includes a first Z-axis value, the second position includes a second Z-axis value, and the pose difference value represents a difference between the second Z-axis value and the first Z-axis value.

19. The device of claim 17, wherein the first position includes a first X-axis value and a first Z-axis value, the second position includes a second X-axis value and a second Z-axis value, and the pose difference value represents a first difference between the second X-axis value and the first X-axis value and a second difference between the second Z-axis value and the first Z-axis value.

20. The device of claim 17, wherein the first position includes a first X-axis value, a first Y-axis value, and a first Z-axis value, the second position includes a second X-axis value, a second Y-axis value, and a second Z-axis value, and the pose difference value represents a first difference between the second X-axis value and the first X-axis value, a second difference between the second Y-axis value and the first Y-axis value, and a third difference between the second Z-axis value and the first Z-axis value.

21. The device of claim 20, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.

22. The device of claim 17, wherein the first position includes a first X-axis value, a first Y-axis value, and a first Z-axis value, the second position includes a second X-axis value, a second Y-axis value, and a second Z-axis value, and the pose difference value represents a first difference between the second X-axis value and the first X-axis value, a rotation between the first Y-axis value and the second Y-axis value, and a second difference between the second Z-axis value and the first Z-axis value.

23. The device of claim 22, wherein the pose difference value comprises a vector having an X-component, a Y-component, and a Z-component, and wherein the pose frame includes an X-component having samples each equal to the X-component of the vector, a Y-component having samples each equal to the Y-component of the vector, and a Z-component having samples each equal to the Z-component of the vector.

24. The device of claim 17, wherein the odometry unit comprises one or more of a vehicle odometer, a global positioning system (GPS) unit, a global navigation satellite system (GNSS) unit, or a smartphone-based location unit.
